(19) United States
(12) Patent Application Publication
(10) Pub. No.: US 2017/0081613 A1
(43) Pub. Date: Mar. 23, 2017

(54) CLEANING COMPOSITIONS COMPRISING AMPHIPHILIC GRAFT COPOLYMERS AND SULFONATE GROUP-CONTAINING COPOLYMERS

(71) Applicant: The Procter & Gamble Company, Cincinnati, OH (US)

(72) Inventors: Xiaoli WANG, Beijing (CN); Xianling ZHAI, Beijing (CN); Peng QIN, Beijing (CN); Xiaoyan LIU, Beijing (CN); Mark Allen SMERZNAK, Beijing (CN); Patrick Christopher STENGER, Fairfield, OH (US); Bonny Kay LUI, Cincinnati, OH (US); Praveen Kumar DEPA, Hyde Park, OH (US); William Coffin SHEAROUSE, Cincinnati, OH (US); Stacey Lee VOSTERS, Cincinnati, OH (US); Rachel Marie HILER, Cincinnati, OH (US); Akiko HEMMI, Osaka (JP); Hirotaka MIZOGUCHI, Osaka (JP); Rika MATSUMOTO, Osaka (JP)

(21) Appl. No.: 14/862,184

(22) Filed: Sep. 23, 2015

(51) Int. Cl. C11D 3/00; C11D 3/37

(52) U.S. Cl. CPC C11D 3/0036; C11D 3/3788; C11D 3/378

(57) ABSTRACT

A cleaning composition containing an amphiphilic graft polymer and a sulfonate group-containing copolymer is provided, which exhibits significant improved whiteness maintenance benefit when used to treat fabrics.

### FIELD OF THE INVENTION

The present invention is in the field of cleaning compositions.

### BACKGROUND OF THE INVENTION

An important purpose of detergents and/or cleaning compositions is to remove soils and stains from fabrics to achieve consumer perceivable cleaning benefit. The ability of a particular detergent or cleaning composition to remove soils and stains is determined not only by the surfactant activity level in the composition, but also by many others factors.

For example, the wash water used with detergents or cleaning compositions may contain various metal ions (e.g., calcium or magnesium ions) that can chemically combine with surfactants in the wash to form insoluble precipitates, which not only render the surfactant ineffective for soil/stain removal, but also form scums that further soil the fabric surface. Therefore, water with a higher concentration of metal ions (i.e., hard water) presents a particularly challenging wash condition. This challenge is further exacerbated by the recent change in consumers' laundering habits that are aiming at reducing energy consumption (e.g., by re-using wash water, such as re-using bath water for laundering) and improving environmental sustainability (e.g., by eliminating phosphate and/or zeolite builders and reducing total surfactant content in detergents) of the laundering processes. This brings additional challenges because re-used wash water tends to have harder (i.e., high concentrations of metal ions) and increased levels of soil contaminants, and elimination of phosphate and/or zeolite builder and reduction of total surfactant content in the detergent or cleaning compositions may lead to significant reduction in the cleaning performance.

Various polymers have been used in detergents or cleaning compositions in recent years as detergent builders in augmenting the cleaning power of surfactants. For example, some polymers can bind calcium ions and/or other alkali earth metal ions in water, thereby improving the water hardness tolerance of the detergents or cleaning compositions and allowing either elimination or significant reduction of conventional phosphate and/or zeolite builders in such compositions. Other polymers can effectively suspend soil particles (either inorganic or organic) that have already been removed from the fabric surface by surfactants, in the wash liquor and prevent their redeposition back onto the fabric surface during subsequent wash and rinse steps.

Water-soluble copolymers formed by polymerization of one or more monomers derived from unsaturated monocarboxylic acid, unsaturated polyalkylene glycol, and sulfonate group-containing hydrocarbons (such as those disclosed in Japanese Patent Application Publication Nos. JP2004-75977 and JP2010-111792A; U.S. Pat. No. 6,451,952 and U.S. Pat. No. 7,390,776) have demonstrated effectiveness as polymeric detergent builders. Specifically, JP2010-111792A discloses a group of copolymers containing structural units derived from sulfonate group-containing monomers, polyoxyalkylene monomers, and carboxylic acid monomers, which exhibited improved effectiveness in anti-soil redeposition and can be used in detergent or cleaning compositions to improve the overall cleaning performance thereof.

However, there is still room for further improvement in the cleaning performance of the afore-mentioned copolymers. In particular, there is a need for laundry detergent compositions with further improved fabric whiteness maintenance benefit (i.e., less reduction in fabric whiteness after repeated wearing and wash cycles over extended periods of time), in comparison with that currently enabled by the afore-mentioned copolymers.

### SUMMARY OF THE INVENTION

The present invention relates to a cleaning composition, preferably a laundry detergent composition and more preferably a liquid laundry detergent composition, which contains an amphiphilic graft copolymer in combination with a sulfonate group-containing copolymer. It is a surprising and unexpected discovery of the present invention that when a sulfonate group-containing copolymer is combined with an amphiphilic graft copolymer in a cleaning composition, the resulting cleaning composition exhibits significant improvement in its cleaning performance, more specifically its whiteness maintenance benefit, in comparison with compositions containing either the sulfonate group-containing copolymer alone or the amphiphilic graft copolymer alone.

An amphiphilic polymer, by definition, is typically characterized by a hydrophilic portion and a hydrophobic portion. The amphiphilic graft copolymer of the present invention contains a polyalkylene oxide backbone (which is hydrophilic) grafted with one or more side chains formed by polymerization of a vinyl ester component (which is hydrophobic), with an average of about 1 or less graft site per 50 alkyleneoxide units. Such graft copolymer may be present in the cleaning composition of the present invention in an amount ranging from about 0.01% to about 20% by total weight of the cleaning composition.

The sulfonate group-containing copolymer used for practicing the present invention contains at least three structural units, (a), (b), and (c).

The first structural unit (a) is derived from a sulfonate group-containing monomer (A).

The second structural unit (b) is derived from a polyoxyalkxylene monomer (B), which can be presented by formula (I) as follows:

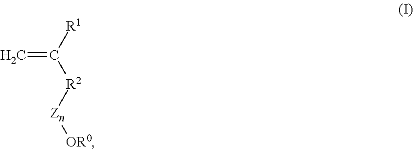

while R¹ represents a hydrogen atom or a methyl group; R² represents a direct bond, CH₂, or CH₂CH₂; Z may be the same or different and each Z represents a structural unit derived from a C₂-C₂₀ alkylene oxide; n is from about 1 to about 200; and R⁰ represents hydrogen atom or a C₁-C₃₀ organic group.

The third structural unit (c) is derived from a carboxyl group-containing monomer (C). The sulfonate group-containing copolymer may be present in the cleaning composition of the present invention in an amount ranging from about 0.01% to about 20% by total weight of the cleaning composition.

The cleaning composition of the present invention can be in any solid or liquid product form. It can be a laundry detergent composition, a hard surface cleaning composition, a hand dishwashing composition, or an automatic dishwashing composition. Preferably, the cleaning composition is in a liquid form and is more preferably in a single phase or multiphase unit dose form as encapsulated by a single compartment or multi-compartment water-solution pouch. It may further comprise, in addition to the amphiphilic graft copolymer and the sulfonate group-containing copolymer as described hereinabove, one or more surfactants selected from the group consisting of anionic surfactants, cationic surfactants, nonionic surfactants, amphoteric surfactants, zwitterionic surfactants, and mixtures thereof. Preferably, the surfactants comprise an anionic surfactant selected from the group consisting of alkyl benzene sulfonate, alkoxylated alkyl sulfates, alkyl sulfates, and mixtures thereof.

The present invention also relates to use of the above-described cleaning composition for treating fabrics to achieve improved whiteness maintenance benefit.

These and other features of the present invention will become apparent to one skilled in the art upon review of the following detailed description when taken in conjunction with the appended claims. Note that preferred embodiments of the present invention include any combination of two or more of those preferred embodiments of the present invention as described hereinbelow.

### DETAILED DESCRIPTION OF THE INVENTION

### Definitions

As used herein, the articles “a” and “an” when used in a claim, are understood to mean one or more of what is claimed or described.

As used herein, the term “substantially free of” or “substantially free from” means that the indicated material is present in an amount of no more than about 5 wt %, preferably no more than about 2%, and more preferably no more than about 1 wt % by weight of the composition.

As used therein, the term “essentially free of” or “essentially free from” means that the indicated material is present in an amount of no more than about 0.1 wt % by weight of the composition, or preferably not present at an analytically detectable level in such composition. It may include compositions in which the indicated material is present only as an impurity of one or more of the materials deliberately added to such compositions.

As used herein the phrase “cleaning composition,” “detergent composition,” or “detergent or cleaning composition” are used interchangeably herein to refer to compositions and formulations designed for cleaning soiled material. Such compositions include but are not limited to, laundry detergent compositions, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-cleaning treatment, a post-cleaning treatment, or may be added during the rinse or wash cycle of the cleaning process. The cleaning compositions may have a form selected from liquid, powder, single-phase or multi-phase unit dose or pouch form, tablet, gel, paste, bar, or flake. In a preferred embodiment of the present invention, the cleaning composition of the present invention is a liquid laundry or dish detergent composition, which is in a single phase or multiphase unit dose form as encapsulated by a single compartment or multi-compartment water-soluble pouch, e.g., formed by a water-soluble polymer such as polyvinyl alcohol (PVA) or copolymers thereof. More preferably, the cleaning composition of the present invention is a liquid laundry detergent composition designated for treating fabrics to achieve improved whiteness maintenance benefit.

As used herein, the term “laundry detergent” means a liquid or solid composition, and includes, unless otherwise indicated, granular or powder-form all-purpose or “heavy-duty” washing agents, especially cleaning detergents as well as cleaning auxiliaries such as bleach additives or pre-treat types. In a preferred embodiment of the present invention, the laundry detergent is a liquid laundry detergent composition.

As used herein, the term “soiled material” refers non-specifically to any type of flexible material consisting of a network of natural or artificial fibers, including natural, artificial, and synthetic fibers, such as, but not limited to, cotton, linen, wool, polyester, nylon, silk, acrylic, and the like, as well as various blends and combinations. Soiled material may further refer to any type of hard surface, including natural, artificial, or synthetic surfaces, such as, but not limited to, tile, granite, grout, glass, composite, vinyl, hardwood, metal, cooking surfaces, plastic, and the like, as well as blends and combinations.

As used herein, the term “water hardness” or “hardness” means uncomplexed cations ion (i.e., Ca²⁺ or Mg²⁺) present in water that have the potential to precipitate under alkaline conditions, and thereby diminishing the surfactancy and cleaning capacity of surfactants. Further, the terms “high water hardness” and “elevated water hardness” can be used interchangeably and are relative terms for the purposes of the present invention, and are intended to include, but not limited to, a hardness level containing at least about 12 grams of calcium ion per gallon water (gpg or “American grain hardness” units).

The term “average molecular weight” of a polymer, unless otherwise specified, typically refers to the weight average molecular weight of polymer chains contain in the polymer composition.

The term “weight average molecular weight” or “average weight-average molecular weight” of a polymer may be calculated using the equation:

M_{w}=(ΣᵢNᵢMᵢ²)/(ΣᵢNᵢMᵢ)

wherein Nᵢ is the number of molecules having a molecular weight Mᵢ. The weight average molecular weight of the sulfonate group-containing copolymer (MW_{S}) is measured by the gel permeation chromatography (GPC) method described in the Test Methods section. The weight average molecular weight of the amphiphilic graft copolymer (MW_{G}) can be measured by the gradient polymer elution chromatography (GPEC) method described in the Test Methods section.

As used herein, the “number average molecular weight” or “average number-average molecular weight” of a polymer may be calculated using the equation:

Mₙ=(ΣᵢNᵢMᵢ)(ΣᵢNᵢ)

wherein Nᵢ is the number of molecules having a molecular weight Mᵢ. The number average molecular weight can be determined in accordance with ASTM Method D6474-12 (2012), unless otherwise specified.

As used herein, the term “polydispersity” refers to the heterogeneity of sizes of molecules in a polymeric mixture, which is calculated as M_{w}/Mₙ, where M_{w} stands for the weight average molecular weight, and Mₙ stands for the number-average molecular weight. The polydispersity of the amphiphilic graft copolymer can be measured by the gradient polymer elution chromatography (GPEC) method described in the Test Methods section.

As used herein, the term “acid form equivalent” means that the proportion (compositional ratio) of the mass of each of the sulfonate group-containing monomer, the carboxyl group-containing monomer, and other acid group-containing monomers of the sulfonate group-containing copolymer of the present invention, which is calculated as the proportion of the acid form of the each monomer. The same shall apply to calculation of the proportion of the mass of the structural unit derived from the monomer relative to the mass of the structural units derived from all monomers contained in the copolymer. For example, calculation of the proportion of the mass of sodium acrylate or a structural unit derived therefrom relative to the mass of all monomer components means calculation of the mass of acrylic acid, or the structural unit derived from acrylic acid, as an acid of sodium acrylate; calculation of the proportion of the mass of sodium 3-allyloxy-2-hydroxypropanesulfonate or a structural unit derived therefrom relative to the mass of all monomer components means calculation of the mass of 3-allyloxy-2-hydroxypropanesulfonic acid, or the structural unit derived from 3-allyloxy-2-hydroxypropanesulfonic acid, as an acid of sodium 3-allyloxy-2-hydroxypropanesulfonate. Further, the proportions of the masses of an amine salt group-containing monomer and an amine salt structure-containing structural unit may also be calculated as the proportions of the masses of an amine (amino group)-containing monomer and an amine structure (amino group structure)-containing structural unit, respectively.

### Amphiphilic Graft Copolymers

The cleaning composition of the present invention contains an amphilic graft copolymer including a hydrophilic portion and a hydrophobic portion. Specifically, such graft copolymer is characterized by a polyalkylene oxide (also referred to as polyalkylene glycol) backbone grafted with one or more side chains that are formed by polymerization of a vinyl ester component.

The polyalkylene oxide backbone of the graft copolymer of the present invention, which is also referred to herein as the graft base, may comprise repeated units of C₂-C₁₀, preferably C₂-C₆, and more preferably C₂-C₄, alkylene oxides. For example, the polyalkylene oxide backbone may be: a polyethylene oxide (PEO) backbone; a polypropylene oxide (PPO) backbone; a polybutylene oxide (PBO) backbone; a polymeric backbone that is a linear block copolymer of PEO, PPO, and/or PBO; and combinations thereof. Preferably, the polyalkylene oxide backbone is a PEO backbone. Such a polyalkylene oxide backbone preferably has a number average molecular weight (Mₙ) from about 1,000 to about 20,000 g/mol, preferably from about 2,000 to about 15,000 g/mol, more preferably from about 3,000 to about 13,000 g/mol, and most preferably from about 5,000 to about 10,000 g/mol.

The polyalkylene oxide backbone may be the corresponding polyalkylene oxides in free form, i.e. with OH end groups, but they may also be capped at one or both end groups. Suitable end groups are, for example, C₁-C₂₅ alkyl, phenyl, and C₁-C₁₄ alkylphenyl groups. Specific examples of particularly suitable polyalkylene oxides include:
polyethylene oxides which may be capped at one or both end groups, especially by C₁-C₂₅ alkyl groups, but are preferably not etherified, and have a number average molecular weight (Mₙ) of preferably from about 1,500 to about 20,000 g/mol, and more preferably from about 2,500 to about 15,000 g/mol;
copolymers of ethylene oxide and propylene oxide and/or butylene oxide with an ethylene oxide content of at least 50% by weight, which may likewise be capped at one or both end groups, especially by C₁-C₂₅ alkyl groups, but are preferably not etherified, and have a number average molecular weight (Mₙ) of preferably from about 1,500 to about 20,000 g/mol, more preferably from about 2,500 to about 15,000 g/mol; and
chain-extended products having number average molecular weights (Mₙ) of from about 2,500 to about 20,000 g/mol, which are obtainable by reacting polyethylene oxides or copolymers described hereinabove with Mₙ of from about 200 to 5,000 g/mol with C₂-C₁₂ dicarboxylic acids or dicarboxylic esters or C₆-C₁₈ diisocyanates.

Preferred graft bases are the polyethylene oxides as described hereinabove.

The polyalkylene oxide backbone may be present in an amount ranging from about 15% to about 70%, preferably from about 25% to about 60%, by total weight of the graft copolymer.

The amphiphilic graft copolymers of the present invention is characterized by a relatively low degree of branching. For example, the molar ratio of grafted to ungrafted alkylene oxide units in the polyalkylene oxide backbone is from about 0.002 to about 0.05, ranges preferably from about 0.002 to about 0.035, more preferably from about 0.003 to about 0.025 and most preferably from about 0.004 to about 0.02. The degree of branching can be determined by ¹³C NMR spectroscopy in deuterated dimethyl sulfoxide from the integrals of the signals of the graft sites and the —CH₂— groups of the polyalkylene oxide backbone. More preferably, the amphiphilic graft copolymer is characterized by an average of about 1 or less graft site (i.e., the site on the polymeric backbone where a polyvinyl ester side chain is grafted thereto) per 50 alkylene oxide units on the backbone.

The one or more side chains of the amphiphilic graft copolymers of the present invention are formed by polymerizations of a vinyl ester component in the presence of the graft base. Suitable vinyl ester components may be selected from C₂-C₁₀ vinyl esters, preferably C₂-C₆ vinyl esters, and more preferably C₂-C₄ vinyl carboxylates. For example, the one or more side chains may be selected from the group consisting of polyvinyl acetate, polyvinyl propionate, polyvinyl butyrate, and combinations thereof, while polyvinyl acetate is preferred. The side chains may also be formed by copolymerizing vinyl acetate and/or vinyl propionate with a further ethylenically unsaturated monomer (e.g., methyl acrylate, ethyl acrylate, and n-butyl acrylate). The fraction of such further ethylenically unsaturated monomer in the total content of the vinyl ester component may be up to 30% by weight. The polyvinyl ester side chains may further be partially saponified, for example, to an extent of up to 15%.

Such side chains may be present in an amount ranging from about 30% to about 85%, preferably from about 40% to about 75%, by total weight of the graft copolymer.

The amphiphilic graft copolymers of the present invention may have an overall weight average molecular weight (M_{w}) of from about 3,000 to about 100,000, preferably from about 10,000 to about 50,000, and more preferably from about 20,000 to about 40,000.

The graft copolymers of the present invention may further feature a narrow molar mass distribution represented by a polydispersity M_{w}/Mₙ of generally ≦about 3, preferably ≦about 2.8, more preferably ≦about 2.5, and even more preferably ≦about 2.3. Most preferably, their polydispersity M_{w}/Mₙ is in the range from about 1.5 to about 2.2.

The amphiphilic graft copolymers of the present invention may be further characterized by a full width at half maximum of the polarity distribution between about 0.35 and about 1.0. Polarity of the amphiphilic graft copolymers of the present invention depends mainly on the weight ratio of the hydrophilic portion over the hydrophobic portion. Higher amounts of the hydrophobic portion, e.g, polyvinylacetate (“PVAc”), in the graft copolymers render the copolymers more apolar, whereas higher amounts of the hydrophilic portion, e.g., polyethylene oxide (“PEG”), render the copolymer more polar. This can be controlled by the weight ratio of PEG and PVAc in the polymerization reaction. The distribution of polarity can be assessed by the gradient polymer elution chromatography (GPEC) method described hereinafter. It is preferred that the graft copolymers of the present invention exhibit a broad distribution of polarity. A broad distribution of polarity can be advantageous especially when polymers are used in detergent compositions. Graft polymers having broad polarity distributions provide a broader variety of cleaning benefits by treating and/or suspending a broader spectrum of soils. Preferably, the graft copolymers of the present invention have a full width at half maximum of the polarity distribution between about 0.40 and about 0.8, preferably between about 0.50 and about 0.75. In certain aspects, the graft copolymers have a full width at half maximum of the polarity distribution between about 0.35 and about 1.0 and a maximum of the polarity distribution between about 0.45 and about 1. In some aspects, the maximum of the polarity distribution is between about 0.5 and about 0.8.

Particularly preferred amphiphilic graft copolymers of the present invention have a polyethylene oxide backbone grafted with one or more side chains of polyvinyl acetate. More preferably, the weight ratio of the polyethylene oxide backbone over the polyvinyl acetate side chains ranges from about 1:0.2 to about 1:10, or from about 1:0.5 to about 1:6, and most preferably from about 1:1 to about 1:5. One example of such preferred amphiphilic graft copolymers is the Sokalan™ HP22 polymer, which is commercially available from BASF Corporation. This polymer has a polyethylene oxide backbone grafted with polyvinyl acetate side chains. The polyethylene oxide backbone of this polymer has a number average molecular weight (Mn) of about 6,000 g/mol (equivalent to about 136 ethylene oxide units), and the weight ratio of the polyethylene oxide backbone over the polyvinyl acetate side chains is about 1:3. The number average molecular weight (Mn) of this polymer itself is about 24,000 g/mol.

Preferably, but not necessarily, the amphiphilic graft copolymers of the present invention have the following properties: (i) the surface tension of a 39 ppm by weight polymer solution in distilled water is from about 40 mN/m to about 65 mN/m as measured at 25° C. by a tensiometer; and (ii) the viscosity of a 500 ppm by weight polymer solution in distilled water is from about 0.0009 to about 0.003 Pa. S as measured at 25° C. by a rheometer. The surface tension of the polymer solution can be measured by any known tensiometer under the specified conditions. Non-limiting tensiometers useful herein include Kruss K12 tensiometer available from Kruss, Thermo DSCA322 tensiometer from Thermo Cahn, or Sigma 700 tensiometer from KSV Instrument Ltd. Similarly, the viscosity of the polymer solution can be measured by any known rheometer under the specified conditions. The most commonly used rheometer is a rheometer with rotational method, which is also called a stress/strain rheometer. Non-limiting rheometers useful herein include Hakke Mars rheometer from Thermo, Physica 2000 rheometer from Anton Paar.

The amphiphilic graft copolymer may be present in the cleaning composition of the present invention in an amount ranging from about 0.01% to about 20%, preferably from about 0.05% to about 15%, more preferably from about 0.1% to about 10%, and most preferably from about 0.5% to about 5%, by total weight of such cleaning composition.

### Sulfonate Group-Containing Copolymer

As mentioned hereinabove, the cleaning composition of the present invention further contains a sulfonate group-containing copolymer comprising: (i) a structural unit (a) derived from a sulfonate group-containing monomer (A); (ii) a structural unit (b) derived from a polyoxyalkylene monomer (B); and (iii) a structural unit (c) derived from a carboxyl group-containing monomer (C).

Sulfonate Group-Containing Monomer (A)

The sulfonate group-containing monomer (A) of the present invention, which is also referred to as a sulfonate group-containing unsaturated monomer, is a monomer having a sulfonate group and a carbon-carbon double bond. The sulfonate group is intended to include sulfonic acids and their salts. Examples of salts of sulfonic acids include, but are not particularly limited to: metal salts, ammonium salts, and organic amine salts of sulfonic acids. Suitable metal salts preferably include, for example, alkali metal ions such as sodium ions or potassium ions; alkaline earth metal ions such as magnesium ions, calcium ions, strontium ions, or barium ions; aluminum ions; or ferric or ferrous ions. Suitable organic amine salts preferably include organic amine groups such as, for example, an alkanolamine such as monoethanolamine, diethanolamine, or triethanolamine; an alkylamine such as monoethylamine, diethylamine, or triethylamine; or a polyamine such as ethylenediamine or triethylenediamine. The salts of sulfonic acids are preferably potassium sulfonate, sodium sulfonate, ammonium sulfonate, or quaternary amines of sulfonic acids.

The sulfonate group-containing monomer (A) may contain one or more sulfonate groups. In one preferred but not necessary embodiment of the present invention, the monomer (A) is represented by the following formula (II):

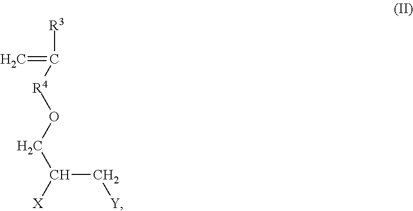

wherein R³ represents a hydrogen atom or a methyl group; R⁴ represents a direct bond, CH₂, or CH₂CH₂; X and Y each represent hydroxy or SO₃M where M represents a hydrogen atom, Li, Na, or K, and at least one of X and Y is SO₃M.

It is preferred that one of X and Y in the above formula (II) is a SO₃M and the other is a hydroxy group. It is more preferred that X is a hydroxy group and Y is a SO₃M. Further, M may represent an ammonium group or an organic amine group as mentioned hereinabove regarding the salts of sulfonic acid. The term “direct bond” as used herein refers to a covalent bond directly connecting two adjacent atoms. Therefore, when R⁴ is a direct bond, the carbon atom and the oxygen atom adjacent to R⁴ are directly connected to each other by a covalent bond without any other atom in between.

Suitable examples of the sulfonate group-containing monomer (A) include, but are not limited to: compounds represented by the formula (II) as described hereinabove, 2-acrylamide-2-methylpropanesulfonic acid, styrene sulfonic acid, (meth)allylsulfonic acid, vinyl sulfonic acid, 2-(meth)allyloxyethylenesulfonic acid, and salts thereof. Specifically, compounds falling within the formula (II) as described hereinabove, such as 3-(meth)allyloxy-2-hydroxypropanesulfonic acid and 3-(meth)allyloxy-1-hydroxypropanesulfonic acid as well as salts thereof are, are preferred examples of the sulfonate group-containing monomer (A) of the present invention because it has been observed that copolymers of the present invention having a structural unit derived from a compound represented by the formula (II) has improved anti-soil redeposition properties and increased preservation stability. In order to more successfully ensure the effect of the present invention enough, 3-allyloxy-2-hydroxypropanesulfonic acid and the sodium salt thereof are more preferred. Alternatively, 2-acrylamide-2-methylpropanesulfonic acid and the sodium salt there of are also preferred examples of the sulfonate group-container monomer (A) for the practice of the present invention.

The sulfonate group-containing copolymer contains preferably from about 1% to about 38% by mass in acid form equivalent of the structural unit (a) in 100% by mass of all structural units constituting the sulfonate group-containing copolymer, more preferably from about 2% to about 30% by mass, still more preferably from about 3% to about 25% by mass, further more preferably from about 4% to about 20% by mass, particularly preferably from about 5% to about 18% by mass, and most preferably from about 5% to about 16% by mass.

Further, the sulfonate group-containing copolymer preferably contains no more than about 1% by mass of the structural unit (a) derived from the sulfonate group-containing monomer (A) that has two or more sulfonate groups, in 100% by mass of all structural units constituting the sulfonate group-containing copolymer.

The structural unit (a) hereinabove is a copolymerized structural unit formed by radical polymerization of the sulfonate group-containing monomer represented by the formula (II), and the structural unit (a) itself can be represented by the following formula (IV):

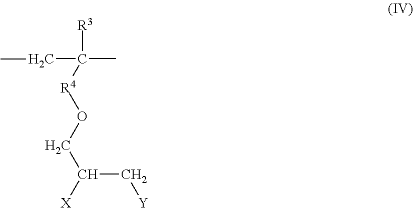

wherein R³R⁴, X, and Y are all the same as defined hereinabove in formula (II).

The method for preparing the sulfonate group-containing monomer (A) is not particularly limited, and any suitable method can be used for the preparation. For example, a method for adding a hydrogen sulfite to the glycidyl group of (meth)allylglycidyl ether is mentioned as an example of a simple method for the preparation.

Polyoxyalkylene Monomer (B)

The polyoxyalkylene monomer (B) of the present invention is characterized by having a structure represented by the following formula (I):

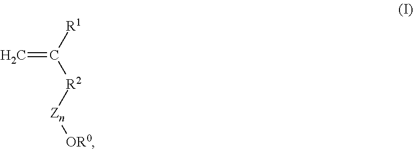

wherein R¹ can be either a hydrogen atom or a methyl group, and R² can be a direct bond, CH₂, or CH₂CH₂. Preferably, R¹ and R² are respectively: (i) a hydrogen atom and CH₂; (ii) a methyl group and CH₂; or (iii) a methyl group and CH₂CH₂. More preferably, R¹ and R² are respectively a methyl group and CH₂, or a methyl group and CH₂CH₂. Most preferably, R¹ and R² are respectively a methyl group and CH₂CH₂.

Z represents one or more structural units, either the same or different from each other, and each of which is derived from a C₂-C₂₀ alkylene oxide. The number “n” represents the average number of alkylene oxide-derived structural repeating units Z, and it is from about 1 to about 200.

R⁰ represents a hydrogen atom or a C₁-C₃₀ organic group. Examples of the organic group in R⁰ include C₁-C₃₀ alkyl, C₂-C₃₀ alkenyl, and C₆-C₃₀ aryl. These may further have a substituent group. Examples of the substituent group include heterocyclic rings, alkoxy groups, aryloxy groups, alkylthio groups, arylthio groups, alkoxycarbonyl groups, aryloxycarbonyl groups, sulfamoyl groups, acyl groups, acyloxy groups, amide groups, carbamoyl groups, ureido groups, alkylsulfonyl groups, arylsulfonyl groups, amino groups, halogens, fluorohydrocarbon groups, cyano groups, nitro groups, hydroxy, mercapto, and silyl groups. Specific examples of the C₁-C₃₀ organic group include methyl, ethyl, butyl, octyl, lauryl, cyclohexyl, phenyl, naphthyl, pyridyl, pyrimidyl, imidazolidyl, morpholyl, butenyl, pentenyl, hexenyl, heptenyl, methylcarbonyl, and ethylcarbonyl. R⁰ is preferably a hydrogen atom or a methyl group, and more preferably a hydrogen atom.

In formula (I), the structural unit Z derived from an alkylene oxide represents an oxyalkylene structural unit containing a ring-opening alkylene oxide. For example, in cases where the alkylene oxide is ethylene oxide (EO), the structural unit Z is a —OCH₂CH₂— (oxyethylene) structural unit containing a ring-opening ethylene oxide. The oxyalkylene structural unit Z is derived from an alkylene oxide having from about 2 to about 20 carbon atoms, preferably from about 2 to about 15 carbon atoms, more preferably from about 2 to about 10 carbon atoms, still more preferably from about 2 to about 5 carbon atoms, particularly preferably from about 2 to about 3 carbon atoms, and most preferably about 2 carbon atoms.

Examples of the structural unit Z derived from an alkylene oxide include structural units derived from compounds such as ethylene oxide (EO), propylene oxide (PO), isobutylene oxide, 1-butene oxide, 2-butene oxide, trimethylethylene oxide, tetramethylene oxide, tetramethylethylene oxide, butadiene monoxide, octylene oxide, styrene oxide, and 1,1-diphenyl ethylene oxide. In particular, the structural unit Z is preferably derived from EO or PO (that is, oxyethylene or oxypropylene), and is more preferably oxyethylene. Such a structural unit can contain a single species of oxyalkylene, or it may contain two or more species of oxyalkylenes.

A preferred polyoxyalkylene monomer (B) of the present invention mainly includes multiple repeating structural units of oxyethylene (—O—CH₂CH₂—). In this case, the phrase “mainly includes . . . oxyethylene” means that if two or more species of oxyalkylenes are present in the monomer, oxyethylene accounts for most of all oxyalkylenes (e.g., no less than about 50 mol %, or preferably no less than about 70 mol %, or more preferably no less than about 80 mol % or about 90 mol %, or most preferably about 100%, relative to 100 mol % of all oxyalkylenes). This allows smooth progress of polymerization in a production process, and provides excellent effects such as improvement in water solubility or anti-redeposition properties. If the proportion of the oxyethylene is not less than about 50 mol %, the hydrophilicity of the group formed by the oxyalkylene can be further improved.

In formula (I), n represents the average number of the alkylene oxide-derived structural repeating units Z, and it can range from about 1 to about 200, preferably from about 5 to about 100, more preferably from about 10 to about 80, and still more preferably from about 20 to about 80 or from about 25 to about 70, and most preferably from about 40 to about 60. When n is in the above preferred ranges, the compatibility with liquid detergents and the anti-redeposition properties of the resulting sulfonate group-containing copolymer tend to be improved.

The sulfonate group-containing copolymer of the present invention preferably contains from about 9% to about 76% by mass of the structural unit (b) in 100% by mass of all structural units constituting the sulfonate group-containing copolymer, more preferably from about 10% to about 70% by mass, still more preferably from about 12% to about 65% by mass, further more preferably from about 15% to about 60% by mass, particularly preferably from about 18% to about 50% by mass or from about 20% to about 49% by mass, and most preferably from about 30% to about 45% by mass. In the calculation of the total weight of all structural units derived from all monomers in the present invention, the weights of the sulfonate group-containing monomer, the carboxyl group-containing monomer, and other acid group-containing monomers contained in all monomer components are calculated as the weights of their acids monomers.

The copolymer of the present invention is characterized by having the structural unit (b) derived from the polyoxyalkylene monomer (B) represented by the formula (II) hereinabove. The structural unit (b) derived from the polyoxyalkylene monomer herein is a copolymerized structural unit formed by radical polymerization of the polyoxyalkylene monomer (B), and is represented by the following formula (III):

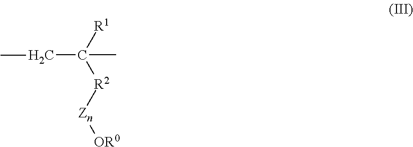

wherein R¹, R², Z, n, and R⁰ are all the same as defined hereinabove in formula (I).

The polyoxyalkylene monomer (B) of the present invention as described hereinabove may be produced by any suitable method. Preferably, it is produced by method (1) in which an alkylene oxide is added to an alcohol having a carbon-carbon double bond, such as allyl alcohol, methallyl alcohol, or isoprenol; alternatively, it is produced by method (2) in which a polyalkylene glycol is added to a halide having a carbon-carbon double bond, such as allyl chloride, methallyl chloride, isoprenyl chloride, or vinyl chloride.

In the above-described method (1), an alkylene oxide is added to an alcohol having a carbon-carbon double bond by, for example, a) anionic polymerization in which a hydroxide of an alkali metal, a strong alkali such as an alkoxide, or alkylamine is used as a base catalyst, b) cationic polymerization in which a halide of a metal or metalloid, mineral acid, or acetic acid is used as a catalyst, or c) coordination polymerization in which a combination of an alkoxide of a metal such as aluminum, iron, or zinc, an alkaline-earth compound, and/or Lewis acid is used. Thus, the alkylene oxide is added to the hydroxy group of the alcohol, and the length of the polyoxyalkylene chain so formed is determined by the charge ratio of the alkylene oxide and the alcohol added during the polymerization.

The polyoxyalkylene monomer (B) of the present invention as described hereinabove has good stability during polymerization. Accordingly, the anti-redeposition properties of the resulting copolymer are improved. Further, the polyoxyalkylene monomer (B) of the present invention as described hereinabove provides a copolymer with favorable temporal stability. Further, when processed into various products (compositions) for various applications, the copolymer of the present invention, i.e., containing the structural unit (b) derived from the polyoxyalkylene monomer (B) as described hereinabove, shows excellent stability, and whereby the resulting products preferably exhibit stable performance.

Carboxyl Group-Containing Monomer (C)

The carboxyl group-containing monomer (C) of the present invention, which is also referred to as a carboxyl group-containing unsaturated monomer, is a monomer having a carboxyl group and a carbon-carbon double bond. The carboxyl group is intended to include carboxylic acids and their salts. Examples of the salts of the carboxylic acids include, but are not particularly limited to, metal salts, ammonium salts, and organic amine salts of carboxylic acids. Preferred examples of metal ions in the metal salts include alkali metal ions such as sodium and potassium ions; alkaline earth metal ions such as magnesium, calcium, strontium, and barium ions; aluminum ions; and ferric or ferrous ions. Further, preferred examples of organic amine groups of the organic amine salts include alkanolamines such as monoethanolamine, diethanolamine, and triethanolamine; alkylamines such as monoethylamine, diethylamine, and triethylamine; polyamines such as ethylenediamine and triethylenediamine. Examples of the salts of the carboxylic acids include lithium salts, potassium salts, sodium salts, ammonium salts, and quaternary amine salts.

Examples of the carboxyl group-containing monomer (C) include (meth)acrylic acid, maleic acid and anhydride thereof, fumaric acid, itaconic acid, crotonic acid, 2-methylene glutaric acid, and salts thereof. Particularly preferred carboxyl group-containing monomer (C) is (meth)acrylic acid, maleic acid or anhydride thereof, or a salt thereof, due to their high polymerizability and their ability to form a copolymer with high anti-redeposition properties. Still more preferred carboxyl group-containing monomer (C) is acrylic acid, maleic acid or anhydride thereof, or a salt thereof. Most preferred carboxyl group-containing monomer (C) is acrylic acid or its salt. In the event where the carboxyl group-containing monomer (C) is a compound that can form an acid anhydride, such as maleic acid, the monomer then may be in the acid anhydride form, such as maleic anhydride. The carboxyl group-containing monomers described hereinabove may be used either alone or in combinations of two, three, four or more.

The sulfonate group-containing copolymer of the present invention contains from about 20% to about 90% by mass in acid form equivalent of the structural unit (c) in 100% by mass of all structural units constituting the sulfonate group-containing copolymer. The amount of the structural unit (c) is preferably from about 25% to about 85% by mass, more preferably from about 25% to about 80% by mass, still more preferably from about 25% to about 75% by mass, still more preferably from about 35% to about 73% by mass, or from about 35% to about 70%, yet more preferably from about 35% to about 55%, and most preferably from about 40% to about 55% by mass. The sulfonate group-containing polymer of the present invention having a proportion of the structural unit (c) of from about 20% to about 90% by mass has improved anti-redeposition properties, particularly anti-redeposition properties against hydrophilic soil under high hardness condition. In order to improve the compatibility with liquid detergents as well as the anti-redeposition properties, the proportion of the structural unit (c) is most preferably from about 40% to about 55% by mass. In light of the structure, the proportion of the mass of the carboxyl group-containing monomer that corresponds to a salt of an acid is calculated as the mass of the acid. In cases where the carboxyl group-containing monomer is an acid anhydride, the mass of the monomer is calculated as the mass of the dicarboxylic acid, which is an acid of the monomer, prepared from the acid anhydride by hydrolysis.

The sulfonate group-containing copolymer of the present invention contains preferably from about 1% to about 100% by mass, more preferably from about 20% to about 100% by mass, still more preferably from about 50% to about 100% by mass, particularly preferably from about 80% to about 100% by mass, and most preferably 100% by mass, in acid form equivalent of a structural unit derived from a monocarboxylic acid such as (meth)acrylic acid in 100% by mass of the total of the structural unit (c) derived from the carboxyl group-containing monomer (C).

The copolymer of the present invention contains the structural unit (c) derived from the carboxyl group-containing monomer (C). The structural unit (c) is a copolymerized structural unit formed by radical polymerization of the carboxyl group-containing monomer (C). For example, in cases where the carboxyl group-containing monomer (C) is acrylic acid or a sodium salt thereof, the corresponding structural unit (c) is represented by —CH₂—CH(COOH)— or —CH₂—CH(COONa)—.

Other Monomers

The sulfonate group-containing copolymer of the present invention may contain an additional structural unit (e) derived from a monomer (E) other than the sulfonate group-containing monomer (A), the polyoxyalkylene monomer (B), and the carboxyl group-containing monomer (C).

The monomer (E) is not particularly limited, provided that it is copolymerizable with the monomers (A), (B), and (C). Examples of suitable monomers (E) include, but are not limited to: hydroxy group-containing alkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and α-(hydroxymethyl)ethyl (meth)acrylate; alkyl (meth)acrylates prepared by esterification of (meth)acrylic acid with a C₁-C₁₈ alcohol, such as methyl (meth)acrylate, ethyl (meth)acrylate, butyl (meth)acrylate, cyclohexyl (meth)acrylate, and lauryl (meth)acrylate; amino group-containing acrylates such as dimethylaminoethyl (meth)acrylate and quaternized dimethylaminoethyl (meth)acrylate; amide group-containing monomers such as (meth)acrylamide, dimethyl acrylamide, and isopropyl acrylamide; vinyl esters such as vinyl acetate; alkenes such as ethylene and propylene; aromatic vinyl monomers such as styrene; maleimide derivatives such as maleimide, phenyl maleimide, and cyclohexyl maleimide; nitrile group-containing vinyl monomers such as (meth)acrylonitrile; phosphonic acid (salt) group-containing monomers such as vinylphosphonic acid, (meth)allylphosphonic acid, and their salts; aldehyde group-containing vinyl monomers such as (meth)acrolein; alkyl vinyl ethers such as methyl vinyl ether, ethyl vinyl ether, and butyl vinyl ether; other functional group-containing monomers such as vinyl chloride, vinylidene chloride, allyl alcohol, and vinyl pyrrolidone. These other monomers may be used either alone or in combinations of two, three, four or more.

The structural unit (e) derived from the monomer (E) herein is a copolymerized structural unit formed by radical polymerization of the monomer (E). For example, in cases where the monomer (E) is methyl acrylate, the structural unit (e) is a structural unit represented by —CH₂—CH(COOCH₃)—.

The sulfonate group-containing copolymer may contain only one structure unit (e) or two or more structure units (e) as described hereinabove.

Preferably, the copolymer of the present invention contains from 0% to about 30% by mass, more preferably from 0% to about 20% by mass, still more preferably from 0% to about 10% by mass, and most preferably 0% by mass of the structural unit (e) derived from the monomer (E) in 100% by mass of all structural units constituting the sulfonate group-containing copolymer.

Preferably, two or more of the structural units (a), (b), (c), and optionally (e) satisfy the above-described proportions (by mass) in the copolymer of the present invention. That is, the copolymer of the present invention containing a combination of the structural units (a), (b), (c) and optionally (e) with the above-described preferred proportions (by mass) is also a preferred embodiment of the copolymer of the present invention. The total of the proportions of the combination is 100% by mass.

The sulfonate group-containing copolymer as described hereinabove preferably contains from about 1% to about 38%, more preferably from about 4% to about 20% and most preferably from about 5% to about 16%, by mass in an acid form equivalent of the structural unit (a) in 100% by mass of all monomer structural units constituting the sulfonate group-containing copolymer. It may also contain from about 9% to about 76%, preferably from about 20% to about 49% and more preferably from about 30% to about 45%, by mass of the structural unit (b) in 100% by mass of all monomer structural units constituting the sulfonate group-containing copolymer. The number “n” in formula (II), which represents the average number of repeating oxyalkylene unit Z, is preferably from about 5 to about 100, more preferably form about 10 to about 80, still more preferably from about 25 to 70, and most preferably from about 40 to about 60. The sulfonate group-containing copolymer may also contain from about 20% to about 90%, preferably from about 25% to about 75% and more preferably from about 35% to about 55%, by mass in acid form equivalent of the structural unit (c) in 100% by mass of all monomer structural units constituting the sulfonate group-containing copolymer.

In a particularly preferred embodiment of the present invention, the sulfonate group-containing copolymer contains:
(i) from about 5% to about 16% by mass of the structure unit (a) in acid form equivalent in 100% by mass of all monomer structural units constituting the sulfonate group-containing copolymer, wherein the sulfonate group-containing monomer (A) is 3-allyloxy-2-hydroxypropanesulfonate;
(ii) from about 30% to about 45% by mass of the structure unit (b) in 100% by mass of all monomer structural units constituting the sulfonate group-containing copolymer, wherein the polyoxyalkylene monomer (B) comprises an ethylene oxide-derived group having from about 40 to about 60 repeating oxyethylene units; and
(iii) from about 35% to about 55% by mass of the structure unit (c) in acid form equivalent in 100% by mass of all monomer structural units constituting the sulfonate group-containing copolymer, wherein the carboxyl group-containing monomer (C) is acrylic acid or a salt thereof,

Further, it is preferred that the sulfonate group-containing copolymer is characterized by a parameter of P×MW_{S}×n that ranges from about 950,000 to about 800,000,000, in which:
P is defined as the ratio by mass of the structural unit (b) to the structural unit (a) in the sulfonate group-containing copolymer is P;
MW_{S} is the weight average molecular weight of the sulfonate group-containing copolymer; and
n is defines as the same hereinabove in formula (I).

The product of P×Mw×n is preferably not less than about 1,000,000, more preferably not less than about 1,500,000, and most preferably not less than about 2,000,000. The product of P×Mw×n is preferably not more than about 500,000,000, more preferably not more than about 100,000,000. For example, it may preferably range from 1,000,000 to 50,000,000.

Without being bound by any theory, it is believe that sulfonate group-containing copolymers characterized by such a parameter have improved adsorption for hydrophilic soil, which in turn leads to further improved anti-soil redeposition efficacy, especially against hydrophilic soil under wash conditions marked by higher water hardness (i.e., higher water hardness tolerance). Cleaning compositions formulated with such sulfonate group-containing copolymers produce a low amount of salt precipitates and have a high washing effect even when used in an area where there is hard water with high concentrations of calcium ions and magnesium ions (for example, not less than 100 mg/L). The effect is particularly remarkable when the cleaning compositions contain an anionic surfactant such as LAS. Further, such cleaning compositions exhibit improved fabric whiteness maintenance benefit and/or satisfactory phase stability when in a liquid form.

Preferably, but not necessarily, the weight average molecular weight (MW_{S}) of the sulfonate group-containing copolymer is from about 20,000 to about 200,000, more preferably from about 22,000 to about 150,000, yet more preferably from about 25,000 to about 100,000, still more preferably from about 30,000 to about 80,000, and most preferably from about 30,000 to about 75,000. Without being bound by any theory, it is believed that the sulfonate group-containing polymer of the present invention with the specified weight average molecular weight MW_{S}, i.e., from about 20,000 to about 200,000 has improved anti-redeposition properties, particularly anti-redeposition properties against hydrophilic soil under high water hardness conditions. On one hand, if the weight average molecular weight MW_{S} of the copolymer is larger than about 200,000, the copolymer may become highly viscous and difficult to handle. On the other hand, if MW_{S} is smaller than about 20,000, the anti-redeposition properties of the copolymer significantly deteriorate, resulting in poorer performance as a detergent builder. The weight average molecular weight MW_{S} of the sulfonate group-containing copolymer of the present invention is determined by the specific method used in the examples as described hereinafter.

The ratio by mass (P) of the structural unit (b) to the structural unit (a) in the sulfonate group-containing copolymer is preferably from about 1.2 to about 20, more preferably from about 1.3 to about 20, yet more preferably from about 1.5 to about 15, still more preferably from about 2 to about 10, and most preferably from about 2.5 to about 5. When the ratio by mass (P) is calculated, the masses of the structural unit (a) and the structural unit (b) are calculated as the masses of the acid form equivalents of them, i.e., P is determined as a mass ratio of the acid form equivalent of the structural unit (b) to the acid form equivalent of the structural unit (a). The ratio by mass of the structural unit (a) to the structural unit (b) to the structural unit (c) can also be expressed in the form of the proportions of the structural units (a), (b), and (c), for example, preferably (2 to 38)/(9 to 76)/(20 to 90), more preferably (2 to 30)/(10 to 70)/(25 to 85), still more preferably (3 to 25)/(12 to 65)/(30 to 80), further more preferably (4 to 20)/(15 to 60)/(35 to 75), particularly preferably (5 to 18)/(18 to 50)/(40 to 73), still more preferably (5 to 16)/(20 to 49)/(43 to 70), and most preferably (5 to 16)/(30-45)/(40-55). The total of the proportions of the structural units (a), (b), and (c) is 100% by mass.

Without being bound by any theory, it is believed that the specific ratio by mass P of the structural unit (b) to the structural unit (a), i.e., from about 1.2 to about 20, contributes to the improved anti-soil redeposition properties of the copolymer of the present invention, particularly its improved anti-redeposition properties against hydrophilic soil under high water hardness conditions. Further, when the ratio by mass P is from about 3 to about 10, it is believed to improve the compatibility of the copolymer with liquid detergents as well as its anti-redeposition properties.

More preferably, the sulfonate group-containing copolymer according to the present invention is characterized by a specific ratio by mass P of the structural unit (b) to the structural unit (a) that ranges from about 1.2 to about 20 and a specific weight average molecular weight MW_{S} of the copolymer that ranges from about 20,000 to about 200,000, while the product of P×MW_{S} is from about 25,000 to about 2,000,000. An improved effect is observed between the ratio by mass P of the structural unit (b) to the structural unit (a) and the weight average molecular weight MW_{S} of the copolymer, when the product of the ratio by mass P multiplied by the weight average molecular weight MW_{S} is in a specific range of from about 25,000 to about 2,000,000. The resulting sulfonate group-containing copolymer exhibits significantly improved anti-soil redeposition properties, particularly anti-redeposition properties against hydrophilic soil under high water hardness conditions. Further, such product of the ratio by mass P multiplied by the weight average molecular weight MW_{S} may lead to significant improvement in the copolymer's compatibility with liquid detergents as well as the anti-redeposition properties. Preferably, the product of the ratio by mass P multiplied by the weight average molecular weight MW_{S} ranges from about 50,000 to about 1,500,000, more preferably from about 70,000 to about 1,200,000, still more preferably from about 100,000 to about 1,000,000, yet still more preferably from about 120,000 to about 1,000,000, and most preferably from about 130,000 to about 1,200,000.

Further, the number n of alkylene oxide-derived structural repeating units in the formula (I) of the structural unit (b) in the sulfonate group-containing copolymer also contributes to improvement of the anti-redeposition properties and liquid detergent compatibility of the copolymer, especially when it is provided within a specific range of from about 5 to about 100, preferably from about 10 to about 80, and more preferably from about 40 to about 60.

The sulfonate group-containing copolymers of the present invention as described hereinabove have improved anti-soil redeposition ability. Given their enhanced anti-soil redeposition properties, the sulfonate group-containing copolymers of the present invention are particularly useful for formulating laundry detergent compositions with improved whiteness maintenance performance and cleaning performance. Further, the sulfonate group-containing copolymers of the present invention exhibit satisfactory liquid detergent compatibility, which renders them useful for formulating liquid laundry detergent products with improved phase stability.

The cleaning composition of the present invention may contain one or more of the above-described sulfonate group-containing copolymers. The sulfonate group-containing copolymer(s) may be present in such cleaning composition in an amount ranging from about 0.01% to about 20%, preferably from about 0.05% to about 15%, more preferably from about 0.1% to about 10%, and most preferably from about 0.5% to about 5%, by total weight of such cleaning composition.

Method of Producing Sulfonate Group-Containing Copolymer

The method of producing the sulfonate group-containing copolymer of the present invention is not particularly limited, and any known polymerization method or a modified method based thereon can be readily used.

The production method preferably involves copolymerizing monomer components including a sulfonate group-containing monomer (A), a polyoxyalkylene monomer (B), a carboxyl group-containing monomer (C), and optionally a monomer (E), which are the same as those described hereinabove.

In order to sufficiently exert the effects of the present invention, the proportion of the sulfonate group-containing monomer (A) is, but not particularly limited to, preferably from about 1% to about 38% by mass, more preferably from about 2% to about 30% by mass, still more preferably from about 3% to about 25% by mass, further more preferably from about 4% to about 20% by mass, particularly preferably from about 5% to about 18% by mass, and most preferably from about 5% to about 16% by mass in acid form equivalent in 100% by mass of all the monomers.

In order to sufficiently exert the effects of the present invention, the proportion of the polyoxyalkylene monomer (B) is, but not particularly limited to, preferably from about 9% to about 76% by mass, more preferably about 10% to about 70% by mass, still more preferably from about 12% to about 65% by mass, further preferably from about 15% to about 60% by mass, particularly preferably from about 18% to about 50% by mass, yet more preferably from about 20% to about 49%, and most preferably from about 30% to about 45% by mass in acid form equivalent in 100% by mass of all the monomers.

In order to sufficiently exert the effects of the present invention, the proportion of the carboxyl group-containing monomer (C) is preferably from about 20% to about 90% by mass, more preferably from about 25% to about 85% by mass, still more preferably from about 25% to about 80% by mass, further more preferably from about 25% to about 75% by mass, particularly preferably from 35% to 73% by mass, yet more preferably from about 35% to about 70%, still more preferably from about 35% to bout 55%, and most preferably from about 40% to about 55% by mass in acid form equivalent in 100% by mass of all the monomers.

The proportion of the monomer (E) is preferably from 0% to about 30% by mass, more preferably from 0% to about 20% by mass, still more preferably from 0% to about 10% by mass, and most preferably 0% by mass in 100% by mass of all the monomers.

The monomer components preferably contain two or more of the sulfonate group-containing monomer (A), the polyoxyalkylene monomer (B), the carboxyl group-containing monomer (C), and optionally the monomer (E) in the above preferred proportions. That is, combination of the sulfonate group-containing monomer (A), the polyoxyalkylene monomer (B), the carboxyl group-containing monomer (C), and optionally the monomer (E) in the above preferred proportions in all the monomers is also a preferred embodiment of the method of producing the sulfonate group-containing copolymer of the present invention.

During copolymerization of the monomer components, the monomer components are preferably copolymerized using a polymerization initiator. The amount of the polymerization initiator to be used in the polymerization reaction may be appropriately controlled depending on the amount of the monomer components to be used, and is not particularly limited. Further, a chain transfer agent, a reaction accelerator (for reducing the amount of the initiator, which can be, e.g., heavy metal ions), a catalyst (for decomposing a polymerization initiator), a reducing compound (e.g., organic compounds such as ferrocene or metal naphtenates, or inorganic reducing compounds), the like can be preferably used in addition to the polymerization initiator.

The combination of polymerization initiator, chain-transfer agent, and reaction accelerator is not particularly limited, and these may be selected from any of those described hereinabove. A most preferred combination of the initiator and the chain transfer agent is the combination of one or more of persulfates and one or more of sulfites.

The copolymerization may be carried out by any method, such as the commonly used methods of solution polymerization, bulk polymerization, suspension polymerization, or emulsion polymerization. Solution polymerization is particularly preferred. The copolymerization may be carried out either continuously or in batches. Known solvents may be used in such copolymerization.

After completion of the polymerization reaction, a suitable alkali component (e.g., alkali metal hydroxides, alkaline earth metal hydroxides, and organic amines) may be appropriately added for post treatment, if needed, and the degree of neutralization (final degree of neutralization) of the resulting sulfonate group-containing copolymer may be set within a predetermined range. The final degree of neutralization is not particularly limited. This is because the final degree of neutralization of the copolymer varies depending on intended use. Accordingly, the final degree of neutralization may be set to an extremely wide range of from about 1 to about 100 mol %.

A copolymer composition formed by the copolymerization process described hereinabove essentially contains the sulfonate group-containing copolymer of the present invention. In addition, the copolymer composition may contain unreacted monomers, unreacted or decomposed polymerization initiator, homopolymers formed by one out of three of the monomers described hereinabove, binary copolymers formed by two out of three of the monomers described hereinabove, a hydrogen sulfite adduct (which is an impurity derived from the carboxyl group-containing monomer which remains unpolymerized although the above hydrogen sulfite and/or the compound capable of producing a hydrogen sulfite as a chain transfer agent is added thereto), and the like. It is preferred that the copolymer composition so formed contains little or no unreacted monomers or homopolymers.

### Cleaning Compositions

The present invention provides a cleaning composition, preferably a laundry detergent composition and more preferably a liquid laundry detergent composition, that contains the amphiphilic graft copolymer and the sulfonate group-containing copolymer as described hereinabove and optionally other adjunct ingredients.

The cleaning composition of the present invention can be in any solid or liquid product form, and it can be a laundry detergent composition, a hard surface cleaning composition, a hand dishwashing composition, and an automatic dishwashing composition. The cleaning composition is preferably a liquid, and even more preferably it is in a single phase or multiphase unit dose form, i.e., the liquid cleaning composition is contained in a single compartment or multi-compartment water-soluble pouch. In a specific embodiment, the cleaning composition is in a single phase or multiphase unit dose form containing either a liquid automatic dishwashing composition or a liquid laundry detergent composition encapsulated in a single compartment or multi-compartment water-soluble pouch, which is formed, for example, by a water-soluble polymer such as polyvinyl alcohol (PVA) and/or polyvinylpyrrolidone (PVP).

When the cleaning composition is in the form of a liquid laundry detergent composition, it may further comprise one or more organic solvents, which can be present in an amount ranging from about 1 wt % to about 80 wt %, preferably from about 10 wt % to about 60 wt %, more preferably from about 15 wt % to about 50 wt %, and most preferably from about 20 wt % to about 45 wt %, by total weight of the composition.

Because phase separation is a constant challenge for liquid laundry detergent compositions, especially when the salt content in such compositions is high, the solvent system of the present invention is particularly designed to stabilize the amphiphilic graft copolymer and the sulfonate group-containing copolymer of the present invention and minimize the risk of phase separation. Specifically, the solvent system of the present invention is composed mostly of diols, such as ethylene glycol, diethylene glycol, propylene glycol, dipropylene glycol, butylene glycol, pentanediols, and combinations thereof. The diols are present in the liquid laundry detergent composition of the present invention in a total amount ranging from about 2 wt % to about 50 wt %. Preferably, the composition contains ethylene, diethylene glycol, and/or propylene glycol in a total amount ranging from about 5 wt % to about 40 wt %. More preferably, the composition contains propylene glycol in the amount ranging from about 15 wt % to about 35 wt %. Other organic solvents may also be present, which include, but are not limited to: methanol, ethanol, glycerin, sodium cumene sulfonate, potassium cumene sulfonate, ammonium cumene sulfonate, sodium toluene sulfonate, potassium toluene sulfonate, sodium xylene sulfonate, potassium xylene sulfonate, ammonium xylene sulfonate, or mixtures thereof. Other lower alcohols, such C₁-C₄ alkanolamines, e.g., monoethanolamine and/or triethanolamine, may also be used. In a particularly preferred embodiment of the present invention, the liquid laundry detergent compositions of the present invention also contain from about 5 wt % to about 20 wt %, preferably from 6 wt % to 18 wt %, more preferably from 8 wt % to 16 wt % of glycerin in addition to the diol(s).

The liquid laundry detergent composition of the present invention preferably contains water in combination with the above-mentioned organic solvent(s) as carrier(s). In some embodiments, water is present in the liquid laundry detergent compositions of the present invention in the amount ranging from about 20 wt % to about 70 wt %, preferably from about 25 wt % to 60 wt %, and more preferably from about 30 wt % to about 50 wt %. In other embodiments, water is absent and the composition is anhydrous. Highly preferred compositions afforded by the present invention are clear, isotropic liquids.

The cleaning composition of the present invention contains one or more surfactants, which may be present in amounts ranging from about 1% to about 80%, more preferably from about 1% to about 50%, and more preferably from about 5% to about 30% by total weight of the compositions. The specific forms of the surfactants and the adjunct cleaning additives are not particularly limited, and are appropriately selected based on common knowledge in the field of detergents. For example, the surfactants are selected from the group consisting of anionic surfactants, cationic surfactants, nonionic surfactants, amphoteric surfactants, zwitterionic surfactants, and mixtures thereof.

Anionic surfactants are preferred. Useful anionic surfactants can themselves be of several different types. For example, non-soap synthetic anionic surfactants are particularly suitable for use herein, which include the water-soluble salts, preferably the alkali metal, and ammonium salts, of organic sulfuric reaction products having in their molecular structure an alkyl group (included in the term “alkyl” is the alkyl portion of acyl groups) containing from about 10 to about 20 carbon atoms and a sulfonic acid or sulfuric acid ester group. Examples of this group of synthetic anionic surfactants include, but are not limited to: a) the sodium, potassium and ammonium alkyl sulfates with either linear or branched carbon chains, especially those obtained by sulfating the higher alcohols (C₁₀-C₂₀ carbon atoms), such as those produced by reducing the glycerides of tallow or coconut oil; b) the sodium, potassium and ammonium alkylethoxy sulfates with either linear or branched carbon chains, particularly those in which the alkyl group contains from about 10 to about 20, preferably from about 12 to about 18 carbon atoms, and wherein the ethoxylated chain has, in average, a degree of ethoxylation ranging from about 0.1 to about 5, preferably from about 0.3 to about 4, and more preferably from about 0.5 to about 3; c) the sodium and potassium alkyl benzene sulfonates in which the alkyl group contains from about 10 to about 20 carbon atoms in either a linear or a branched carbon chain configuration, preferably a linear carbon chain configuration; d) the sodium, potassium and ammonium alkyl sulphonates in which the alkyl group contains from about 10 to about 20 carbon atoms in either a linear or a branched configuration; e) the sodium, potassium and ammonium alkyl phosphates or phosphonates in which the alkyl group contains from about 10 to about 20 carbon atoms in either a linear or a branched configuration, f) the sodium, potassium and ammonium alkyl carboxylates in which the alkyl group contains from about 10 to about 20 carbon atoms in either a linear or a branched configuration, and combinations thereof; g) the sodium, potassium and ammonium alkyl ester sulfonates, for example of formula R—CH(SO₃M)-CH₂COOR′, or the sodium, potassium and ammonium alkyl ester sulfates, for example of formula R—CH(OSO₃M)-CH₂COOR′, where R represents a C₁₀-C₂₀ and preferably C₁₀-C₁₆ linear or branched alkyl radical, R′ represents a C₁-C₆ and preferably C₁-C₃ alkyl radical, and M represents a sodium, potassium or the ammonium cation. The anionic surfactants can be provided in the cleaning compositions of the present invention at levels ranging from about 1% to about 80%, more preferably from about 1% to about 50%, more preferably from about 5% to about 30%, and most preferably from 10% to 25%, by total weight of the compositions.

In one particularly preferred embodiment, the cleaning composition of the present invention is a liquid laundry or dish detergent composition containing from about 1 wt % to about 50 wt % of one or more anionic surfactants selected from the group consisting of C₁₀-C₂₀ linear alkyl benzene sulphonates, C₁₀-C₂₀ linear or branched alkylethoxy sulfates having an average degree of ethoxylation ranging from 1 to 5, C₁₀-C₂₀ linear or branched alkyl sulfates, C₁₀-C₂₀ linear or branched alkyl ester sulfates, C₁₀-C₂₀ linear or branched alkyl sulphonates, C₁₀-C₂₀ linear or branched alkyl ester sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof. More preferably, said one or more anionic surfactants are selected from the group consisting of C₁₀-C₂₀ linear alkyl benzene sulphonates, C₁₀-C₂₀ linear or branched alkylethoxy sulfates having an average degree of ethoxylation ranging from about 1 to about 5, methyl ester sulfonates with a C₁₀-C₂₀ linear or branched alkyl group, and mixtures thereof, and are present in an amount ranging from about 5 wt % to about 30 wt % of the liquid laundry or dish detergent composition.

Water-soluble salts of the higher fatty acids, i.e., “soaps”, are also useful anionic surfactants in the cleaning compositions of the present invention. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. However, the cleaning compositions of the present invention preferably contains soaps at a relatively low level, e.g., no more than about 3 wt %, more preferably not more than about 2 wt % or 1 wt %, and most preferably said cleaning composition is essentially free of soaps.

Nonionic surfactants can also be included into the surfactant systems of the present invention, which include those of the formula R¹(OC₂H₄)ₙOH, wherein R¹ is a C₈-C₁₈ alkyl group or alkyl phenyl group, and n is from about 1 to about 80. Particularly preferred are C₈-C₁₈ alkyl alkoxylated alcohols having an average degree of alkoxylation from about 1 to about 20. The nonionic surfactants can be provided in the cleaning compositions at levels ranging from about 0.05 wt % to about 20 wt %, preferably from about 0.1 wt % to about 10 wt %, and most preferably from about 1 wt % to about 5 wt %. However, in certain preferred embodiments of the present invention, the cleaning compositions contains nonionic surfactants at a relatively low level, e.g., no more than about 3 wt %, more preferably not more than about 2 wt % or 1 wt %, and most preferably said cleaning composition is essentially free of nonionic surfactants.

Other surfactants useful herein include amphoteric surfactants, zwitterionic surfactants and cationic surfactants. Such surfactants are well known for use in laundry or dish detergents and are typically present at levels from about 0.2 wt %, 0.5 wt % or 1 wt % to about 10 wt %, 20 wt % or 30 wt %.

In a preferred but not necessary embodiment of the present invention, the cleaning composition is a liquid dish detergent composition containing from about 0.5 wt % to about 20 wt % of one or more amphoteric and/or zwitterionic surfactants.

Preferred amphoteric surfactants are selected from the group consisting of amine oxide surfactants, such as, for example, alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides are characterized by a formula R₁—N(R₂)(R₃)—O, wherein R₁ is a C₈₋₁₈ alkyl, and wherein R₂ and R₃ are independently selected from the group consisting of C₁₋₃ alkyls and C₁₋₃ hydroxyalkyls, such as methyl, ethyl, propyl, isopropyl, 2-hydroxyethyl, 2-hydroxypropyl and 3-hydroxypropyl. As used herein “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 is from about 10 to about 24 carbon atoms, preferably from about 12 to about 20, and more preferably from about 10 to about 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least about 50 wt %, more preferably at least about 75 wt % to about 100 wt %, of the mid-branched amine oxides for use herein. Particularly preferred amphoteric surfactants are C₁₀-C₁₄ alkyl dimethyl amine oxides.

Preferred zwitterionic surfactants are betaine surfactants, such as, for example, alkyl betaines, alkylamidobetaines, amidazoliniumbetaines, sulfobetaines (also referred to as sultaines) as well as phosphobetaines. A particularly preferred betaine is cocoamidopropylbetaine.

The liquid detergent composition as described herein above may also contain an external structurant, which may be present in an amount ranging from about 0.001% to about 1.0%, preferably from about 0.05% to about 0.5%, more preferably from about 0.1% to about 0.3% by total weight of the composition. Suitable external structurants include those described, for example, in US2007/169741 and US2005/0203213. A particularly preferred external structurant for the practice of the present invention is hydrogenated castor oil, which is also referred to as trihydroxylstearin and is commercially available under the tradename Thixin®.

In yet another preferred embodiment of the present invention, the liquid detergent composition further contains from about 0.1 wt % to about 5 wt %, preferably from about 0.5 wt % to about 3 wt %, more preferably from about 1 wt % to about 1.5 wt %, of one or more fatty acids and/or alkali salts thereof. Suitable fatty acids and/or salts that can be used in the present invention include C₁₀-C₂₂ fatty acids or alkali salts thereof. Such alkali salts include monovalent or divalent alkali metal salts like sodium, potassium, lithium and/or magnesium salts as well as the ammonium and/or alkylammonium salts of fatty acids, preferably the sodium salt.

The balance of the cleaning composition of the present invention typically contains from about 5 wt % to about 70 wt %, or about 10 wt % to about 60 wt % adjunct ingredients.

Suitable adjunct ingredients for laundry detergent products include: builders, chelating agents, dye transfer inhibiting agents, dispersants, rheology modifiers, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, free perfume oils, and/or pigments. In addition to the disclosure below, suitable examples of such other adjunct ingredients and levels of use are found in U.S. Pat. Nos. 5,576,282, 6,306,812, and 6,326,348. The precise nature of these adjunct ingredients and the levels thereof in the liquid laundry detergent composition will depend on factors like the specific type of the composition and the nature of the cleaning operation for which it is to be used.

Suitable adjunct ingredients for dish detergent products include: builders, chelants, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic and inorganic cations such as alkaline earth metals such as Ca/Mg-ions and diamines, antibacterial agents, preservatives and pH adjusters and buffering means.

If the cleaning composition of the present invention is provided in a powder form, it may also be especially preferred for the powder to comprise low levels, or even be essentially free, of builder. The term “essentially free” means that the composition “comprises no deliberately added” amount of that ingredient. In a preferred embodiment, the cleaning composition of the present invention comprises no builder.

### Processes of Making Cleaning Compositions

The cleaning compositions of the present invention can be formulated into any suitable form and prepared by any process chosen by the formulator. Such process typically involves mixing the essential and optional ingredients in any desired order to a relatively uniform state, with or without heating, cooling, application of vacuum, and the like, thereby providing cleaning compositions containing ingredients in the requisite concentrations.

In one embodiment, the cleaning composition herein is a liquid composition contained within a water-soluble film thereby forming a water-soluble pouch. The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load.

The water-soluble film of the pouch preferably comprises a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film comprises polyvinyl alcohol, e.g., M8639 available from MonoSol.

The pouch herein may comprise a single compartment or multiple compartments, preferably comprise multiple compartments, e.g., two compartments or three compartments. In the multi-compartment execution, one or more of the multiple compartments comprise the aforementioned anti-microbial laundry detergent composition. Preferably, the pouch comprises multiple films which form the multiple compartments, i.e., the inner volume of the multiple films is divided into the multiple compartments. The pouch of the present invention can be made by any suitable processes known in the art.

### Methods of Using Cleaning Compositions

The present invention includes methods of using the cleaning compositions described hereinabove for cleaning soiled material. As will be appreciated by one skilled in the art, the cleaning compositions of the present invention are suited for use in laundry pretreatment applications, laundry cleaning applications, and home care applications.

Such methods include, but are not limited to, the steps of contacting the cleaning compositions in neat form or diluted in wash liquor, with at least a portion of a soiled material and then optionally rinsing the soiled material. The soiled material may be subjected to a washing step prior to the optional rinsing step.

For use in laundry pretreatment applications, the method may include contacting the detergent or cleaning compositions described herein with soiled fabric. Following pretreatment, the soiled fabric may be laundered in a washing machine or otherwise rinsed.

Machine laundry methods may comprise treating soiled laundry with an aqueous wash solution in a washing machine having dissolved or dispensed therein an effective amount of a machine laundry cleaning composition in accord with the invention. An “effective amount” of the cleaning composition means from about 20 g to about 300 g of product dissolved or dispersed in a wash solution of volume from about 5 L to about 65 L. The water temperatures may range from about 5° C. to about 100° C. The water to soiled material (e.g., fabric) ratio may be from about 1:1 to about 30:1. The compositions may be employed at concentrations of from about 500 ppm to about 15,000 ppm in solution. In the context of a fabric laundry composition, usage levels may also vary depending not only on the type and severity of the soils and stains, but also on the wash water temperature, the volume of wash water, and the type of washing machine (e.g., top-loading, front-loading, top-loading, vertical-axis Japanese-type automatic washing machine).

The cleaning compositions herein may be used for laundering of fabrics at reduced wash temperatures. These methods of laundering fabric comprise the steps of delivering a laundry detergent composition to water to form a wash liquor and adding a laundering fabric to said wash liquor, wherein the wash liquor has a temperature of from about 0° C. to about 20° C., or from about 0° C. to about 15° C., or from about 0° C. to about 9° C. The fabric may be contacted to the water prior to, or after, or simultaneous with, contacting the laundry detergent composition with water.

Another method includes contacting a nonwoven substrate impregnated with an embodiment of the detergent or cleaning composition with soiled material. As used herein, “nonwoven substrate” can comprise any conventionally fashioned nonwoven sheet or web having suitable basis weight, caliper (thickness), absorbency, and strength characteristics. Non-limiting examples of suitable commercially available nonwoven substrates include those marketed under the tradenames SONTARA® by DuPont and POLYWEB® by James River Corp.

Hand washing/soak methods, and combined handwashing with semi-automatic washing machines, are also included.

### Test Methods

Various techniques are known in the art to determine the properties of the cleaning compositions of the present invention comprising the alkoxylated polyalkyleneimines and the sulfonate group-containing copolymers. However, the following assays disclosed in this section are used to determine the respective values of the parameters of the present invention.

Test 1: Measurement of Weight Average Molecular Weight of Sulfonate Group-Containing Copolymers (MW_{S})

The weight average molecular weight of the sulfonate group-containing copolymers (MW_{S}) are determined by the technique of Gel Permeation Chromatography (GPC) under the following conditions.
Measuring device: L-7000 series (product of Hitachi Ltd.)
Detector: RI (weight average molecular weight), UV (residual monomer)
Column: SHODEX Asahipak GF-310-HQ, GF-710-HQ, GF-1G 7B (products of Showa Denko K. K.)
Column temperature: 40° C.
Flow velocity: 0.5 mL/min
Calibration curve: Polyacrylic Standard (product of Sowa Kagaku Co., Ltd.)
Eluent: 0.1 N sodium acetate/acetonitrile=3/1 (mass ratio)

Test 2: Measurement of Solids Content

A mixture of 1.0 g of a sulfonate group-containing polymer composition of the present invention and 1.0 g of water is left in an oven heated to 130° C. in nitrogen atmosphere for one hour so as to be dried. The solids content (%) and volatile component content (%) are calculated from the weight difference before and after the drying step.

Test 3: Measurement of Weight Average Molecular Weight of Amphiphilic Graft Copolymers (MW_{G}) and Polydispersity Thereof

The weight average molecular weight (MW_{G}) and polydispersity of the amphiphilic graft copolymers of the present invention are determined by the technique of Gradient Polymer Elution Chromatography (GPEC) under the following conditions.

Test solutions are prepared by dissolving polymer samples in tetrahydrofuran (THF) with a concentration of 10 g/l. Of the solution, 2 μl is injected in the HPLC measurement device. The separation is done using a Waters XBridge Hilic HPLC column with dimensions of 4.6×50 mm and a particle size of 2.5 μm. The eluent starting conditions are 100% acetonitrile (ACN), after 0.3 ml the composition is changed linear to a composition of 60%/40% water/acetonitrile within 5.7 ml. Subsequently, the composition is changed to 95%/5% water/acetonitrile within 0.3 ml. The chromatographic column is rinsed using 1.5 ml of the last mentioned eluent composition and reset within 0.3 ml to initial condition. The volumetric flow is 3 ml/min and the column temperature is 80° C. For detection, an evaporative light scattering detector (ELSD, type PL-ELS 2100 by Polymer Laboratories GmbH, Darmstadt) is used (ELSD conditions: blue LED wavelength=480 nm, evaporation temperature=85° C., nebulizer temperature=50° C., gas flow=1.5 SLM (standard liter per minute)).

The following columns and settings are used: Column: Waters XBridge Hilic; i.D. 4.6 mm; length 50 mm; column temperature: 80° C., flow rate: 3 ml/min; injection volume: 2 ml; concentration: 10 mg/ml; gradient.

| Volume | H₂O by weight | ACN by weight | Time in min |
|---|---|---|---|
| 0.15 | 0 | 100 | 0 |
| 0.45 | 0 | 100 | 0.1 |
| 6.15 | 60 | 40 | 2 |
| 6.25 | 95 | 5 | 2.033 |

As reference materials, polyethylene glycol (molecular weight 6000 g/mol, available as Pluriol® E 6000 from BASF SE), and polyvinylacetate (molecular weight 50,000 g/mol, available from Alfa Aesar Company) are used. Care is taken that the molecular weight of the polyethylene glycol reference is the same as that of the polyethylene glycol used as the graft base for synthesis of the amphiphilic graft polymer of the present invention.

The relative polarity and the polarity distribution of the amphiphilic graft polymer may be determined by analyzing the GPEC signals of the graft polymer sample as well as the GPEC signals of polyethylene glycol and polyvinylacetate, as reference compounds. The quantification of the polarity of the product is performed by analyzing the results from the GPEC chromatograms, either considering them as non-normal distributions (Modern Engineering Statistics, Thomas P. Ryan, Wiley-Interscience, John Wiley & Sons, Inc., Hoboken, N.J., 2007) or taking the maximum of the polarity distribution and the full width at half maximum of the polarity distribution. Two homopolymers are used as reference to convert these chromatograms into a polarity distribution expressed in % of polyvinylacetate. That means that μ is 0, when polyvinylacetate is 0 and μ is 1, when polyethyleneglycol is 1.

To describe the shape of the distribution of the polymers' polarity, the second central moment, σ², and its mean value, μ, are calculated. The square root of σ² is the analogue of the standard deviation for a continuous univariate probability distribution. By comparing the value of σ for the different graft polymer samples, a measure of the width, or spread, around the expected value μ of the polarity can be obtained.

Another possible way to analyze the data of the polarity measurement, i.e. to transform the results obtained by the GPEC method into numeric results, would be to use the ratio of broadness and height, meaning the full width at half maximum of the polarity distribution divided by the peak height at the maximum of the polarity distribution. This would be compared to the references and the maximum broadness between the two homopolymer references to normalize the results.

Test 4: Whiteness Maintenance Assay

This test is intended to measure the ability of the laundry detergent to prevent loss in whiteness (i.e., whiteness maintenance) of fabrics. Whiteness maintenance of fabrics is evaluated by image analysis after single or multi-cycle washes. Typically, “whiteness” can be reported by its whiteness index, which is conveniently converted from CIELAB (an internationally recognized color scale system developed by CIE (“Commission Internationale de I'Eclairage”)). CIE color scale for whiteness is the most commonly used whiteness index and refers to measurements made under D65 illumination, which is the standard representation of outdoor daylight. In technical terms, whiteness is a single number index referencing the relative degree of whiteness (of near-white materials under specific lighting conditions), and the higher the number, the whiter the material. As an example, for a perfect reflecting, non-fluorescent white material, the CIE whiteness index (L*) would be 100.

The steps for assaying whiteness maintenance of sample laundry detergents are as follows:
(1) Dissolve 2.25 g of raw materials of a base laundry detergent in 300 g of triple-filtered (0.1 micron Millipore membrane filter is used with a vacuum Buchner filtering apparatus) deionized water according to the concentrations as provided in Table 1 herein to form a 1.5× concentrated base wash solution.

TABLE 1
FORMULATION OF CONCENTRATED BASE WASH
SOLUTION (1.5X)

| Raw Materials | Amount (wt %) |
|---|---|
| Water | 76.21% |
| NaOH (for adjusting pH to 7.5%) | 3.23% |
| Propylene glycol | 2.50% |
| Citric Acid | 1.70% |
| Alkylethoxy sulfates with a weight average degree | 9.84% |
| of ethoxylation of about 3 (AE3S) | |
| Linear alkyl benzene sulphonic acid (HLAS) | 6.52% |
| Total | 100.00% |

(2) Transfer 10 ml of the prepared 1.5× concentrated base wash solution into a 40 ml glass vial.
(3) The 10 ml wash solution is then mixed with 900 ul of a polymer solution that contains 1% of the polymer blend according to the present invention (i.e., containing an amphiphilic graft copolymer and a sulfonate group-containing copolymer at 1:1 ratio), or 1% of a comparative polymer alone (i.e., either the amphiphilic graft copolymer alone or the sulfonate group-containing copolymer alone).
(4) Add Teflon-coated magnets into the 40 ml glass vial to provide additional agitation.
(5) Add 2.1 ml of deionized (DI) water into the 40 ml glass vial.
(6) Add 1 ml of a 225 gpg stock hard water solution to the 40 ml glass vial. The 225 gpg stock hard water solution is prepared by the following steps: (i) into a 1000 ml beaker, 4.24 g of CaCl₂.2H₂O and 1.96 g of MgCl₂.6H₂O are added; (ii) add 993.8 ml of de-ionized water; (iii) use a stirring bar and stirring plate to stir the mixture until it is fully dissolved and the solution turns clear; (iv) pour the solution into a 1 L volumetric flask and fill it to the 1 L line; (v) add a stirring bar into the volumetric flask and stir again for about 5 minutes; (vi) remove the stirring bar and refill the volumetric flask with de-ionized water up to the 1 L line; (vii) the resulting 225 gpg stock hard water solution is stored in a plastic bottle for future use.
(7) Add 1 ml of a 75% Arizona Dust clay solution into the solution in the 40 mL glass vial to form a test solution having a total volume of about 15 ml. Accordingly, the clay concentration in the test solution is about 5 wt %. The Arizona Dust clay solution is made by the following steps: (i) add 7.5 g of Arizona Dust clay into a 100 ml beaker and then add 92.5 g of de-ionized water thereinto; (ii) use a stirring bar and a stirring plate to stir the mixture for at least 30 mins until the clay is dissolved.
(8) Fabrics used for conducting this test are selected from 1.5 cm-diameter polyester fabrics (PW19) and 1.5 cm-diameter cotton fabrics (CW98) purchased from Empirical Manufacturing Company (Blue Ash, Cincinnati). Eight (8) of the polyester fabrics or the cotton fabrics are added into the test solution in the 40 mL glass vial to perform the whiteness test via a fast wash cycle.
(9) The 40 ml glass vial containing the test solution and the test fabrics (either the PW19 polyester fabrics or the CW98 cotton fabrics) are secured tightly to one shaking arm of a Wrist Action Shaker Model 75 (Burrell Scientific, Pittsburgh, Pa.) and shaken for about 20 minutes to mimic a wash cycle.
(10) At the end of the wash, the liquid contents of the 40 ml glass vial are emptied through a Buchner funnel.
(11) The test fabrics remaining inside the 40 ml glass vial are then transferred to another 40 ml glass vial, into which 15 mL of a rinse solution is added. The rinse solution is prepared by adding 1 ml of the 225 gpg stock hard water solution as described hereinabove in Step (6) into 14.00 ml of de-ionized filtered water.
(12) The 40 ml glass vial containing the rinse solution and the test fabrics are secured tightly to one shaking arm of the Wrist Action Shaker and shaken for about 3 minutes to mimic a rinse cycle.
(13) At the end of the rinse, the 40 ml glass vial is removed from the Wrist Action Shaker, and the test fabrics are taken out of the glass vial and placed on a black plastic board template to air dry over night.
(14) Two whiteness measurements are carried out for each test fabric using the CIELab color parameters with a Datacolor spectrometer, which include a first whiteness measurement before the wash and rinse cycle (i.e., initial) and a second whiteness measurement after the wash and rinse cycle (i.e., treated).
(15) The difference between the average whiteness measurement of the initial fabrics and that of the treated fabrics is reported as delta W (i.e., ΔW), which is calculated for each test solution as follows:

ΔW=Average Whiteness of Treated Fabrics−Average Whiteness of Initial Fabrics,
Typically, ΔW is a negative value, which is reflective of whiteness loss suffered by fabrics after washing.
(16) A Whiteness Index (ΔWI) is calculated for each polymer or polymer blend tested as follows:

ΔWI=ΔW_{PT}−ΔW_{PR}
wherein:
   ΔW_{PT}=ΔW of the test solution containing the test polymer or polymer blend;
   ΔW_{PR}=ΔW of the base wash solution nil polymer (i.e., reference);
ΔW_{PT} and ΔW_{PR} are typically measured in the same test setting. Specifically, the test solution containing the test polymer or polymer blend and the reference solution (i.e., the base wash solution nil polymer) are added into different glass vials, which are then placed on different but adjacent shaking arms on the Wrist Action Shaker and shaken simultaneously to mimic the wash and rinse cycles.
(17) The Whiteness Index (ΔWI) of a test polymer or polymer blend represents the polymer or polymer blend's relative effectiveness in preventing whiteness loss of a fabric caused by washing, in comparison with that of the reference solution (i.e., the base wash solution nil polymer). A positive ΔWI value indicates that the test polymer or polymer blend is more effective in reducing or preventing fabric whiteness loss than the reference solution. A negative ΔWI value indicates that the test polymer or polymer blend is less effective than the reference solution. The higher the ΔWI value, the more effective is the test polymer or polymer blend.

### Examples

Hereinafter, the present invention is described in more detail based on examples. All percentages are by weight unless otherwise specified.

### A. Exemplary Amphiphilic Graft Copolymers

Exemplary amphiphilic graft copolymers used herein include polyvinylacetate (PVAc) grafted polyethylene oxide (PEG) copolymers having a PEG backbone with multiple PVAc side chains grafted thereon. The PEG-PVAc graft copolymers can be either Sokalan™ HP22, or a copolymer having a PEG backbone with Mn of about 6,000 g/mol and a weight ratio of PEG/PVAc ranging from about 40 to about 60 with about 1 or less graft site per 50 alkyleneoxide units.

### B. Exemplary Sulfonate Group-Containing Copolymers

Following is a list of exemplary sulfonate group-containing copolymers (“S Copolymers”) that can be used for practicing the present invention:

TABLE 2

| | Proportion of | | | | | | |
|---|---|---|---|---|---|---|---|
| | Structural Units | | | | | | |
| | (% by mass) | | | IPN/HAPS | MWₛ | | |
| | HAPS¹ | IPN² | AA³ | (P) | (Dalton) | P × MWₛ | P × MWₛ × n |
| S Copolymer 1 | 10 | 40 (n = 10) | 50 | 4.0 | 27,000 | 108,000 | 1,080,000 |
| S Copolymer 2 | 12 | 34 (n = 25) | 54 | 2.8 | 32,000 | 90,667 | 2,266,000 |
| S Copolymer 3 | 11 | 40 (n = 50) | 49 | 3.6 | 42,000 | 153,000 | 7,640,000 |
| S Copolymer 4 | 9 | 40 (n = 50) | 51 | 4.4 | 72,000 | 320,000 | 16,000,000 |
| S Copolymer 5 | 13 | 64 (n = 50) | 23 | 4.9 | 44,000 | 217,000 | 10,800,000 |
| S Copolymer 6 | 5 | 49 (n = 50) | 46 | 9.8 | 68,000 | 666,000 | 33,300,000 |
| S Copolymer 7 | 27 | 35 (n = 50) | 38 | 1.3 | 15,000 | 19,400 | 972,000 |
| S Copolymer 8 | 16 | 34 (n = 50) | 50 | 2.1 | 12,000 | 25,500 | 1,280,000 |
| S Copolymer 9 | 12 | 40 (n = 50) | 48 | 3.3 | 25,000 | 83,333 | 4,166,000 |
| S Copolymer 10 | 11 | 34 (n = 50) | 55 | 3.1 | 57,000 | 176,182 | 8,809,000 |
| S Copolymer 11 | 15 | 42 (n = 50) | 44 | 2.8 | 70,000 | 196,000 | 9,800,000 |

¹HAPS stands for sodium 3-allyloxy-2-hydroxypropanesulfonate.
²IPN stands for an isoprenol-ethylene oxide adduct, wherein the number “n” defines the avearge number of repeating EO units in such adduct.
³AA stands for acrylic acid.

### C. Improved Whiteness Maintenance Performance Achieved by Inventive Polymer Blend

Whiteness maintenance performance of an inventive polymer blend containing an amphiphilic graft copolymer and a sulfonate group-containing polymer according to the present invention is compared with that of an amphiphilic graft copolymer alone and with that of a sulfonate group-containing polymer alone. Specifically, the Whiteness Index (ΔWI) of the inventive polymer blend, an amphiphilic graft copolymer alone, and a sulfonate group-containing polymer alone, and are measured by using the Whiteness Maintenance Assay as described hereinabove in Test 4, and the corresponding results are tabulated hereinafter in Table 3.

TABLE 3

| | ΔWI (PW19) | ΔWI (CW98) |
|---|---|---|
| S Copolymer 4 alone | 18.21 | 22.77 |
| Graft Copolymer alone* | 17.61 | 26.22 |
| S Copolymer4 + Graft Copolymer | 19.85 | 28.92 |
| (1:1 Ratio) | | |

*This is the copolymer having a PEG backbone with Mn of about 6,000 g/mol and a weight ratio of PEG/PVAc ranging from about 40 to about 60 with about 1 or less graft site per 50 alkyleneoxide units, as described in Example A.

The whiteness maintenance assay test results hereinabove clearly demonstrate that an inventive polymer blend according to the present invention exhibits superior whiteness maintenance performance over that of either an amphiphilic graft copolymer alone or a sulfonate group-containing copolymer alone, when all are used at the same total polymer concentration, which is both surprising and unexpected.

### D. Exemplary Cleaning Compositions

(1). Exemplary Liquid Laundry Detergent Compositions

The following liquid laundry detergent compositions are prepared by traditional means known to those of ordinary skill in the art by mixing the following ingredients.

TABLE 4

| Ingredients (wt %) | 1A | 1B | 1C |
|---|---|---|---|
| AES¹ | 17 | 2 | 11 |
| LAS² | 2.8 | 15 | 10 |
| AE³ | 2.3 | 2.37 | 3.44 |
| Citric Acid | 5 | 1.98 | — |
| Boric Acid | — | 1 | 3 |
| Amine Oxide | 1.2 | — | 0.5 |
| Trimethyl Lauryl Ammonium | — | 1.5 | — |
| Chloride | | | |
| Graft Copolymers of Example A | 0.1~1.5 | 1 | 0.5 |
| S Copolymer 1-11 of Example B | 0.1~1.5 | 1 | 0.5 |
| Fatty Acids | 1.2 | 1.2 | 1.2 |
| Protease (54.5 mg/g)⁴ | 7.62 | 7.98 | 2.08 |
| Amylase (29.26 mg/g)⁵ | 2.54 | 2.67 | 0.69 |
| Xyloglucanase⁶ | — | — | 0.15 |
| Borax | 4.72 | 4.94 | — |
| Calcium Formate | 0.15 | 0.16 | 0.16 |
| Ethoxylated Polyethylenimine⁷ | 1.65 | 1.73 | 1.74 |
| Hexamethylene diamine, | — | — | 1.68 |
| ethoxylated, quaternized, sulfated⁸ | | | |
| DTPA⁹ (50% active) | 0.28 | 0.3 | 0.64 |
| Tiron ® | 0.84 | 0.89 | — |
| Optical Brightener¹⁰ | 0.34 | 0.37 | 0.36 |
| Ethanol | 0.97 | 4.1 | 2.99 |
| Propylene Glycol | 4.9 | 5.16 | 8.49 |
| Diethylene Glycol | — | — | 4.11 |
| Monoethanolamine (MEA) | 1.12 | 1.17 | 0.23 |
| Caustic Soda (NaOH) | 3.5 | 3.74 | 2.1 |
| Na Formate | 0.61 | 0.64 | 0.23 |
| Na Cumene Sulfonate | — | — | 1 |
| Suds Suppressor | — | — | 0.18 |
| Dye | 0.01 | — | 0.02 |
| Perfume | 0.85 | — | 1 |
| Preservative¹¹ | 0.05 | 0.5 | — |
| Hydrogenated castor oil | — | — | 0.27 |
| Water | Q.S. | Q.S. | Q.S. |

¹AES can be AE_{1.5}S, AE₂S, and/or AE₃S, in the amount ranging from 0-20%.
²LAS can be provided in the amount ranging from 0-20%.
³AE is a C12-14 alcohol ethoxylate, with an average degree of ethoxylation of 7-9, supplied by Huntsman, Salt Lake City, Utah, USA. It can be provided in the amount ranging from 0-10%.
⁴Proteases may be supplied by Genencor International, Palo Alto, California, USA (e.g., Purafect Prime ®, Excellase ® or by Novozymes, Bagsvaerd, Denmark (e.g. Liquanase ®, Coronase ®).
⁵Available from Novozymes, Bagsvaerd, Denmark (e.g., Natalase ®, Mannaway ®).
⁶Available from Novozymes (e.g., Whitezyme ®).
⁷Polyethyleneimine (MW = 600) with 20 ethoxylate groups per —NH.
⁸A compound having the following general structure: bis((C₂H₅O)(C₂H₄O)ₙ)(CH₃)—N⁺—CₓH₂ₓ—N⁺—(CH₃)-bis((C₂H₅O)(C₂H₄O)ₙ), wherein n = from 20 to 30, and x = from 3 to 8, or sulphated or sulphonated variants thereof, available from BASF as Lutenzit Z 96 ®
⁹DTPA is diethylenetriaminepentaacetic acid supplied by Dow Chemical, Midland, Michigan, USA.
¹⁰Suitable Fluorescent Whitening Agents are for example, Tinopal ® AMS, Tinopal ® CBS-X, Sulphonated zinc phthalocyanine Ciba Specialty Chemicals, Basel, Switzerland. It can be provided in the amount ranging from 0-5%.
¹¹Suitable preservatives include methylisothiazolinone (MIT) or benzisothiazolinone (BIT), which can be provided in the amount ranging from 0-1%.

(2). Exemplary Liquid Detergent Compositions for Use in Unit Dose (UD) Products

The following liquid detergent compositions are prepared and encapsulated in a multi-compartment pouch formed by a polyvinyl alcohol-film.

TABLE 5

| | A | B |
|---|---|---|
| Usage (g) | 25.36 | 24.34 |
| Usage (ml) | 23.7 | 22.43 |
| Wash Volume (L) | 64 | 64 |
| Anionic/Nonionic ratio | 1.73 | 9.9 |
| Ingredients (wt %) | | |
| Linear C₉-C₁₅ Alkylbenzene sulfonic acid | 18.25 | 22.46 |
| HC24/25 AE2/3S 90/10 blend | 8.73 | 15.29 |
| C₁₂₋₁₄ alkyl 9-ethoxylate | 15.56 | 3.82 |
| Citric Acid | 0.65 | 1.55 |
| Fatty acid | 6.03 | 6.27 |
| Chelants | 1.16 | 0.62 |
| Graft Copolymers of Example A | 1~4 | 1.5 |
| S Copolymers 1-11 of Example B | 1~4 | 1.5 |
| Enzymes | 0.11 | 0.12 |
| Brightener 49 | 0.18 | 0.19 |
| Structurant | 0.1 | 0.1 |
| Solvent system* | 20.31 | 17.96 |
| Water | 10.31 | 11.66 |
| Perfume | 1.63 | 1.7 |
| Aesthetics | 1.48 | 1.13 |
| Mono-ethanolamine or NaOH (or mixture | 6.69 | 9.75 |
| thereof) | | |
| Other laundry adjuncts/minors | Q.S. | Q.S. |

*May include, but not limited to propanediol, glycerol, ethanol, dipropyleneglycol, polyetheyleneglycol, polypropyleneglycol.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
(1) from 0.01% to 20% by weight of a graft copolymer comprising a polyalkylene oxide backbone grafted with one or more side chains formed by polymerization of a vinyl ester component, wherein the graft copolymer has an average of 1 or less graft site per 50 alkylenexoxide units;
(2) from 0.01% to 20% by weight of a sulfonate group-containing copolymer that comprises:
a structural unit (a) derived from a sulfonate group-containing monomer (A); and
a structural unit (b) derived from a polyoxyalkylene monomer (B) represented by formula (I): 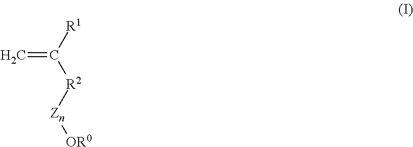
wherein R¹ represents a hydrogen atom or a methyl group; R² represents a direct bond, CH₂, or CH₂CH₂; Z may be the same or different and each Z represents a structural unit derived from a C₂-C₂₀ alkylene oxide; n is from 1 to 200; and R⁰ represents hydrogen atom or a C₁-C₃₀ organic group; and
a structural unit (c) derived from a carboxyl group-containing monomer (C).

2. The cleaning composition of claim 1, wherein the graft copolymer has a weight average molecular weight (MW_{G}) of from 3,000 to 100,000.

3. The cleaning composition according to claim 1, wherein the polyalkylene oxide backbone of the graft copolymer is selected from the group consisting of: a polyethylene oxide backbone; a polypropylene oxide backbone; a polybutylene oxide backbone; a polymeric backbone that is a linear block copolymer of polyethylene oxide, polypropylene oxide, and/or polybutylene oxide; and combinations thereof; and
wherein the polyalkylene oxide backbone is preferably present in an amount ranging from 15% to 70%, more preferably from 25% to 60%, by weight of the graft copolymer.

4. The cleaning composition according to claim 1, wherein the vinyl ester component used for forming said one or more side chains by polymerization is selected from the group consisting of polyvinyl acetate, polyvinyl propionate, polyvinyl butyrate, and combinations thereof, and wherein said one or more side chains are preferably present in an amount ranging from 30% to 85%, more preferably from 40% to 75%, by weight of the graft copolymer.

5. The cleaning composition according to claim 1, wherein the graft copolymer comprises a polyethylene oxide backbone grafted with one or more side chains of polyvinyl acetate, and wherein the weight ratio of the polyethylene oxide backbone over the polyvinyl acetate side chains ranges from 1:0.2 to 1:10, preferably from 1:0.5 to 1:6.

6. The cleaning composition according to claim 1, wherein said graft copolymer is present in an amount ranging from 0.05% to 15%, preferably from 0.1% to 10%, and more preferably from 0.5% to 5%, by total weight of the cleaning composition.

7. The cleaning composition according to claim 1, wherein the sulfonate group-containing copolymer comprises:
from 1% to 38%, preferably from 4% to 20% and more preferably from 5% to 16%, by mass in an acid form equivalent of the structural unit (a) in 100% by mass of all monomer structural units constituting the sulfonate group-containing copolymer; and
from 9% to 76%, preferably from 20% to 49% and more preferably from 30% to 45%, by mass of the structural unit (b) in 100% by mass of all monomer structural units constituting the sulfonate group-containing copolymer; and
from 20% to 90%, preferably from 25% to 75% and more preferably from 35% to 55%, by mass in acid form equivalent of the structural unit (c) in 100% by mass of all monomer structural units constituting the sulfonate group-containing copolymer.

8. The cleaning composition according to claim 1, wherein said sulfonate group-containing copolymer is characterized by a parameter of P×MW_{S}×n that ranges from 950,000 to 8,000,000, and preferably from 1,000,000 to 50,000,000, wherein:
P is defined as the ratio by mass of the structural unit (b) to the structural unit (a) in the sulfonate group-containing copolymer; and
MW_{S} is the weight average molecular weight of the sulfonate group-containing copolymer; and
n is as defined in formula (I).

9. The cleaning composition according to claim 8, wherein MW_{S} ranges from 20,000 to 200,000, preferably from 25,000 to 100,000, and more preferably from 30,000 to 75,000; and wherein P ranges from 1.2 to 20, preferably from 1.5 to 15, more preferably from 2 to 10, and most preferably from 2.5 to 5; and wherein n ranges from 5 to 100, preferably from 10 to 80, and more preferably from 40 to 60.

10. The cleaning composition according to claim 1, wherein the sulfonate group-containing monomer (A) is a compound represented by the following formula (II): 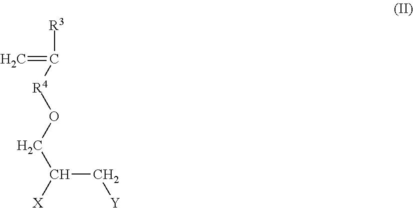
wherein R³ represents a hydrogen atom or a methyl group; R⁴ represents a direct bond, CH₂, or CH₂CH₂; X and Y each represent a hydroxy group or SO₃M where M represents a hydrogen atom, Li, Na, or K, and at least one of X and Y is SO₃M.

11. The cleaning composition according to claim 1, wherein said sulfonate group-containing copolymer is present in an amount ranging from 0.05% to 15%, preferably from 0.1% to 10%, and more preferably from 0.5% to 5%, by total weight of the cleaning composition.

12. The cleaning composition according to claim 1, which is selected from the group consisting of a laundry detergent composition, a hard surface cleaning composition, a hand dishwashing composition, and an automatic dishwashing composition; wherein the cleaning composition preferably is a laundry detergent composition, and more preferably a liquid laundry detergent composition; and wherein the cleaning composition further comprises a surfactant selected from the group consisting of anionic surfactants, cationic surfactants, nonionic surfactants, amphoteric surfactants, zwitterionic surfactants, and mixtures thereof, and wherein said surfactant is preferably an anionic surfactant selected from the group consisting of alkyl benzene sulfonate, alkoxylated alkyl sulfates, alkyl sulfates, and mixtures thereof.

13. Use of the cleaning composition according to claim 1 for treating fabrics to achieve improved whiteness maintenance benefit.

14. A method of treating a soiled material, comprising the steps of:
a) providing a cleaning composition according to claim 1;
b) contacting the cleaning composition with at least a portion of the soiled material; and
c) optionally, rinsing the soiled material.
